(19) United States
(12) Patent Application Publication
(10) Pub. No.: US 2025/0148751 A1
(43) Pub. Date: May 8, 2025

(54) INFORMATION PROCESSING DEVICE, AND DETERMINATION METHOD

(71) Applicant: Mitsubishi Electric Corporation, Tokyo (JP)

(72) Inventors: So Osawa, Tokyo (JP); Takahiro Kashima, Tokyo (JP)

(73) Assignee: Mitsubishi Electric Corporation, Tokyo (JP)

(21) Appl. No.: 19/016,102

(22) Filed: Jan. 10, 2025

Related U.S. Application Data
(63) Continuation of application No. PCT/JP2022/037153, filed on Oct. 4, 2022.

(51) Int. Cl. G06V 10/56

(52) U.S. Cl. CPC G06V 10/56

(57) ABSTRACT

An information processing device includes an acquisition unit that acquires XYZ values being values corresponding to a recognition target region as an image region in an image obtained by photographing an object under first illumination and being values represented in an XYZ color model, a spectral distribution, spectral reflectance in a case of a perfect reflecting diffuser, and a determination table indicating a correspondence relationship between Lab values being values in an L*a*b* color space and a color, a calculation unit that calculates Lab values as values corresponding to the recognition target region in the L*a*b* color space by using the XYZ values, the spectral distribution and the spectral reflectance, and a determination unit that determines color of the recognition target region by using the calculated Lab values and the determination table.

### CROSS-REFERENCE TO RELATED APPLICATION

This application is a continuation application of International Application No. PCT/JP2022/037153 having an international filing date of Oct. 4, 2022, which is hereby expressly incorporated by reference into the present application.

### BACKGROUND OF THE INVENTION

### 1. Field of the Invention

The present disclosure relates to an information processing device, and a determination method.

### 2. Description of the Related Art

There has been known a technology for determining the color of an object included in an image. Further, there are cases where the color of an object included in an image differs from the original color due to influence of illumination. For example, when the original color of the object is blue color and the illumination is in yellow color, the color of the object included in the image becomes blackish color due to the influence of the illumination. In such a circumstance, color correction has been proposed (see Patent Reference 1). A color correction device in the Patent Reference 1 calculates color information regarding each pixel of an output image based on color information regarding each pixel of an input image, spectral distribution of the illumination in a restored input image, and spectral distribution of the illumination in the output image. In calculation of the spectral distribution of the illumination in the output image, spectral distribution of illumination designated as target illumination is used. The spectral distribution of the designated illumination is calculated based on correlated color temperature of CIE daylight.
Patent Reference 1: WO 2007/007788

With the above-described technology, the color correction can be made in cases of standard illumination such as the CIE daylight. However, there exist various types of illumination. Thus, with the above-described technology, the original color cannot be determined in cases of various types of illumination.

### SUMMARY OF THE INVENTION

An object of the present disclosure is to determine the original color.

An information processing device according to an aspect of the present disclosure is provided. The information processing device includes an acquisition unit that acquires XYZ values being values corresponding to a recognition target region as an image region in an image obtained by photographing an object under first illumination and being values represented in an XYZ color model, a spectral distribution obtained by using spectral distribution data including data of the first illumination or data similar to the data of the first illumination and principal component analysis, spectral reflectance in a case of a perfect reflecting diffuser, and determination information indicating a correspondence relationship between Lab values being values in an L*a*b* color space and a color, a calculation unit that calculates Lab values as values corresponding to the recognition target region in the L*a*b* color space by using the XYZ values, the spectral distribution and the spectral reflectance, and a determination unit that determines color of the recognition target region by using the calculated Lab values and the determination information.

According to the present disclosure, the original color can be determined.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing hardware included in an information processing device;

FIG. 2 is a block diagram showing functions of the information processing device;

FIG. 3 is a diagram showing an example (No. 1) of a determination table;

FIG. 4 is a flowchart showing an example of a color determination process;

FIG. 5 is a diagram showing an example (No. 2) of the determination table;

FIG. 6 is a diagram showing an example (No. 1) of a management table; and

FIG. 7 is a diagram showing an example (No. 2) of the management table.

### DETAILED DESCRIPTION OF THE INVENTION

An embodiment will be described below with reference to the drawings. The following embodiment is just an example and a variety of modifications are possible within the scope of the present disclosure.

### Embodiment

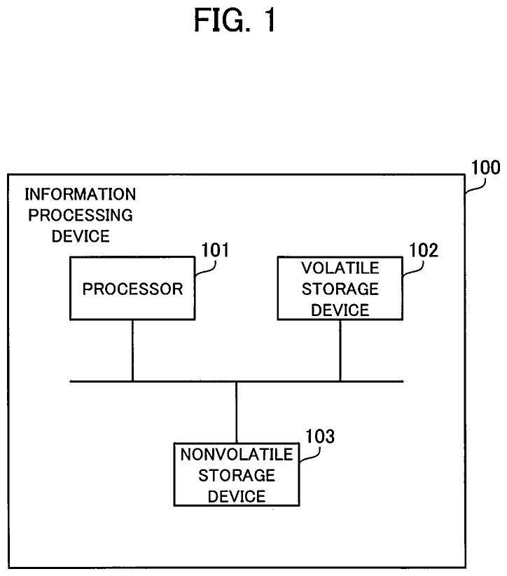

FIG. 1 is a diagram showing hardware included in an information processing device. The information processing device 100 is a device that executes a determination method. The information processing device 100 is a Personal Computer (PC), a smartphone, a tablet terminal, a server or the like. In the case where the information processing device 100 is a server, for example, the information processing device 100 executes data communication with a tablet terminal.

The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Next, functions included in the information processing device 100 will be described below.

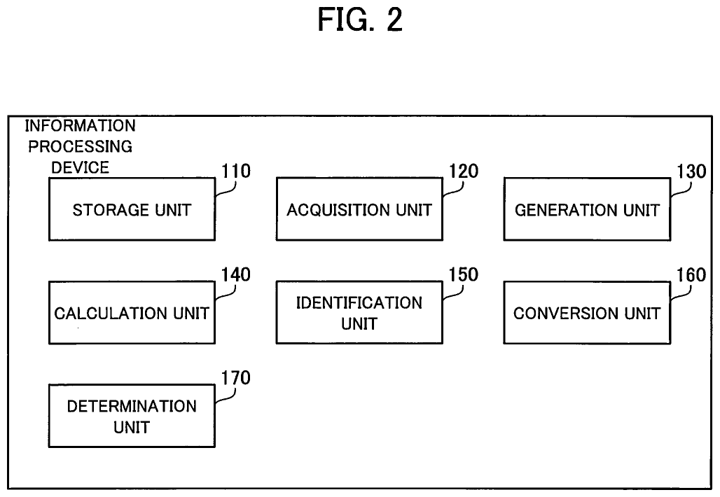

FIG. 2 is a block diagram showing the functions of the information processing device. The information processing device 100 includes a storage unit 110, an acquisition unit 120, a generation unit 130, a calculation unit 140, an identification unit 150, a conversion unit 160 and a determination unit 170.

The storage unit 110 may be implemented as a storage area reserved in the volatile storage device 102 or the nonvolatile storage device 103.

Part or all of the acquisition unit 120, the generation unit 130, the calculation unit 140, the identification unit 150, the conversion unit 160 and the determination unit 170 may be implemented by processing circuitry. Further, part or all of the acquisition unit 120, the generation unit 130, the calculation unit 140, the identification unit 150, the conversion unit 160 and the determination unit 170 may be implemented as modules of a program executed by the processor 101. For example, the program executed by the processor 101 is referred to also as a determination program. The determination program has been recorded in a record medium, for example.

The information processing device 100 uses spectral distribution P_{ε}(λ) in a color determination process. Therefore, generation of the spectral distribution P_{ε}(λ) will be described below.

### <Generation of Spectral Distribution P_{ε}(λ)>

The storage unit 110 stores a variety of information.

The acquisition unit 120 acquires XYZ values of a reference color. The XYZ values are values represented in the XYZ color model. For example, the acquisition unit 120 acquires the XYZ values from the storage unit 110 or an external device. The external device is a cloud server, for example. Incidentally, illustration of the external device is left out.

It is also possible for the acquisition unit 120 to acquire calculated XYZ values. Specifically, the acquisition unit 120 acquires an image. Incidentally, this image is an image obtained by photographing an object under first illumination. The first illumination is illumination in a factory or the like. For example, the first illumination is sodium illumination, white Light Emitting Diode (LED) illumination or the like. The acquisition unit 120 acquires RGB values from an image region in the reference color (e.g., image region representing a housing). Incidentally, the image region in the reference color may have been determined previously. In cases where a camera generating the image generated the image based on sRGB ITU-R BT. 709, the calculation unit 140 calculates the XYZ values from the RGB values by using expression (1).

$$( \begin{matrix}X \\ Y \\ Z\end{matrix} ) = ( \begin{matrix}0.4124 & 0.3576 & 0.1805 \\ 0.2126 & 0.7152 & 0.0722 \\ 0.0193 & 0.1192 & 0.9505\end{matrix} ) ( \begin{matrix}R \\ G \\ B\end{matrix} ) / 255 * 80 \qquad ( 1 )$$

As above, the acquisition unit 120 may acquire calculated XYZ values.

The acquisition unit 120 acquires spectral distribution data including data of the first illumination from the storage unit 110 or an external device. Incidentally, the spectral distribution data may be represented also as data of the first illumination (i.e., spectral distribution data of the first illumination). The spectral distribution data may include data similar to the data of the first illumination. For example, in cases where the first illumination is sodium illumination, the spectral distribution data may include data similar to data of the sodium illumination. Further, the spectral distribution data may include data of a plurality of types of illumination. For example, the spectral distribution data includes data of a plurality of types of illumination such as sodium illumination, white LED illumination, etc. installed in a factory. The external device is a spectral irradiance meter or the like, for example.

The generation unit 130 generates an expression representing top three principal components by using the spectral distribution data and principal component analysis. The expression is represented by expression (2), where a₁, as and a₃ are parameters. Incidentally, the three parameters are unknown values. The three parameters are calculated as will be described later. P₁, P₂ and P₃ represent the top three principal components.

$$P ( λ ) = {a}_{1} * {P}_{1} + {a}_{2} * {P}_{2} + {a}_{3} * {P}_{3} \qquad ( 2 )$$

As above, P(λ) is obtained by using the principal component analysis for the spectral distribution data. Here, P(λ) is referred to as a spectral distribution model. The generation unit 130 may generate the spectral distribution model P(λ) by using the principal component analysis and a value obtained by dividing the spectral distribution data including data of one or more types of illumination by an energy mean value.

The acquisition unit 120 acquires spectral reflectance ρ(λ) of a spot in the reference color (e.g., a spot on the housing). For example, the acquisition unit 120 acquires the spectral reflectance ρ(λ) from the storage unit 110 or the external device.

The calculation unit 140 calculates the parameters a₁, a₂ and a₃ by using the XYZ values acquired by the acquisition unit 120, the spectral distribution model P(λ) and the spectral reflectance ρ(λ). Specifically, the calculation unit 140 calculates the parameters a₁, a₂ and a₃ by using expression (3).

$$\{ \begin{matrix}X & = K {\int }_{380}^{780} P ( λ ) * ρ ( λ ) * \overline{x} ( λ ) d λ \\ Y & = K {\int }_{380}^{780} P ( λ ) * ρ ( λ ) * \overline{y} ( λ ) d λ \\ Z & = K {\int }_{380}^{780} P ( λ ) * ρ ( λ ) * \overline{z} ( λ ) d λ\end{matrix} \qquad ( 3 )$$

Incidentally, K is a constant. The overlined x(λ), y(λ) and z(λ) are color matching functions.

Since there are three equations, the calculation unit 140 is capable of calculating three unknown parameters. The calculation unit 140 substitutes the calculated parameters a₁, a₂ and as into the spectral distribution model P(λ). By this, the spectral distribution model P(λ) in which the three parameters have become clear is obtained. The spectral distribution model P(λ) in which the three parameters have become clear is referred to as the spectral distribution PE(λ). The calculation unit 140 may store the spectral distribution PE(λ) in the storage unit 110 or the external device.

Next, the color determination process will be described below.

### <Color Determination Process>

The acquisition unit 120 acquires an image. For example, the acquisition unit 120 acquires the image from a camera that generated the image. Incidentally, this image is an image obtained by photographing an object under the first illumination.

The identification unit 150 identifies a recognition target region in the image. For example, the identification unit 150 identifies a predetermined region as the recognition target region. Alternatively, for example, the identification unit 150 identifies a marker region in the image as the recognition target region. The identification unit 150 may identify a plurality of recognition target regions. Incidentally, the recognition target region is an image region.

The calculation unit 140 calculates the XYZ values, as values corresponding to the recognition target region, based on the recognition target region. Specifically, the calculation unit 140 calculates the XYZ values based on the RGB values of the recognition target region. For example, the calculation unit 140 calculates the XYZ values by using the expression (1). Incidentally, the XYZ values are values represented in the XYZ color model.

The acquisition unit 120 acquires the calculated XYZ values. Here, it is permissible even if the XYZ values are calculated by an external device. In the case where the XYZ values were calculated by an external device, the acquisition unit 120 acquires the XYZ values from the external device.

The acquisition unit 120 acquires the spectral distribution P_{ε}(λ) from the storage unit 110 or an external device.

The acquisition unit 120 acquires spectral reflectance ρ1 (λ) in a case of a perfect reflecting diffuser (fully diffuse reflective surface) from the storage unit 110 or an external device.

The calculation unit 140 calculates Lab values, as values corresponding to the recognition target region in an L*a*b* color space, by using the XYZ values, the spectral distribution P_{ε}(λ) and the spectral reflectance ρ1 (λ). Specifically, the calculation unit 140 calculates the Lab values by using expression (4). The Lab values are referred to also as L*a*b* values.

$$\{ \begin{matrix}L * & = 116 {( \frac{Y}{{Y}_{n}} )}^{\frac{1}{3}} - 16 \\ a * & = 500 \{ {( \frac{X}{{X}_{n}} )}^{\frac{1}{3}} - {( \frac{Y}{{Y}_{n}} )}^{\frac{1}{3}} \} \\ b * & = 200 \{ {( \frac{Y}{{Y}_{n}} )}^{\frac{1}{3}} - {( \frac{Z}{{Z}_{n}} )}^{\frac{1}{3}} \}\end{matrix} \qquad ( 4 )$$

Xₙ, Yₙ and Zₙ are represented by using expression (5).

$$\{ \begin{matrix}{X}_{n} & = K {\int }_{380}^{780} {P}_{E} ( λ ) * ρ 1 ( λ ) * \overline{x} ( λ ) d λ \\ {Y}_{n} & = K {\int }_{380}^{780} {P}_{E} ( λ ) * ρ 1 ( λ ) * \overline{y} ( λ ) d λ \\ {Z}_{n} & = K {\int }_{380}^{780} {P}_{E} ( λ ) * ρ 1 ( λ ) * \overline{z} ( λ ) d λ\end{matrix} \qquad ( 5 )$$

The conversion unit 160 converts the calculated Lab values to LCh values as values corresponding to the recognition target region in an L*C*h color space. Specifically, the conversion unit 160 converts the Lab values to the LCh values by using expression (6). The LCh values are referred to also as L*C*h values.

$$\{ \begin{matrix}C * & = \sqrt{{{( a \text{*)}}^{2} + ( b \text{*)}}^{2}} \\ h & = {tan}^{- 1} ( \frac{b *}{a *} )\end{matrix} \qquad ( 6 )$$

The acquisition unit 120 acquires a determination table from the storage unit 110 or an external device. An example of the determination table will be shown below.

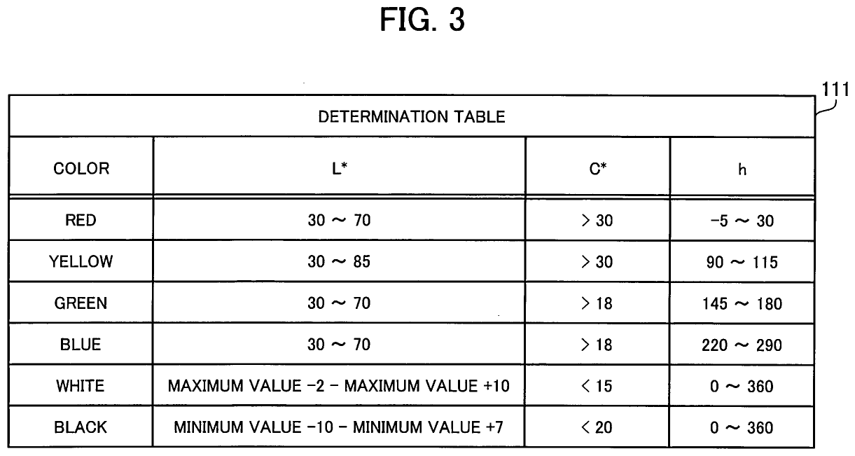

FIG. 3 is a diagram showing an example (No. 1) of the determination table. For example, the determination table 111 is stored in the storage unit 110. The determination table 111 is referred to also as determination information. The determination table 111 indicates a correspondence relationship between the LCh values being values in the L*C*h color space and colors.

The determination unit 170 determines the color of the recognition target region by using the LCh values obtained by the conversion and the determination table 111. Specifically, the determination unit 170 determines the color of the recognition target region by using the L* value, the C′ value, the h value and the determination table 111.

Next, the color determination process executed by the information processing device 100 will be described below by using a flowchart.

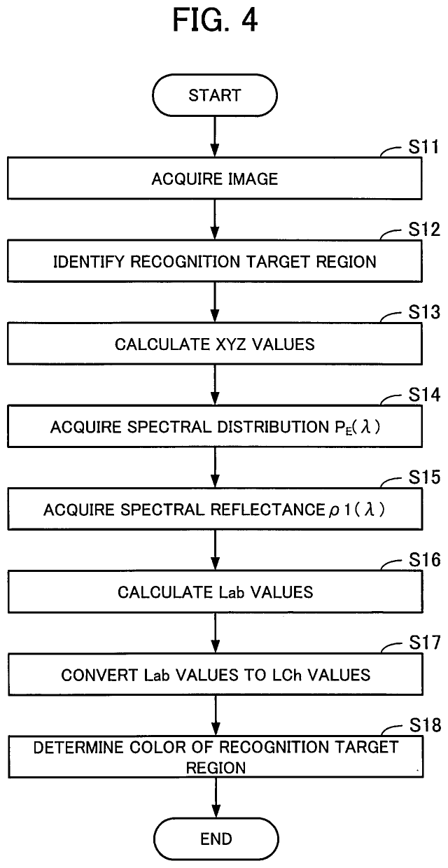

FIG. 4 is a flowchart showing an example of the color determination process.

(Step S11) The acquisition unit 120 acquires an image.

(Step S12) The identification unit 150 identifies the recognition target region in the image.

(Step S13) The calculation unit 140 calculates the XYZ values based on the recognition target region.

(Step S14) The acquisition unit 120 acquires the spectral distribution P_{ε}(λ) from the storage unit 110.

(Step S15) The acquisition unit 120 acquires the spectral reflectance ρ1 (λ) from the storage unit 110.

(Step S16) The calculation unit 140 calculates the Lab values by using the XYZ values, the spectral distribution P_{ε}(λ) and the spectral reflectance ρ1 (λ).

(Step S17) The conversion unit 160 converts the Lab values to the LCh values.

(Step S18) The determination unit 170 determines the color of the recognition target region by using the LCh values and the determination table 111.

According to the embodiment, the information processing device 100 is capable of eliminating the influence of the illumination by using the spectral distribution P_{ε}(λ). Therefore, the information processing device 100 is capable of determining the original color. Further, one or more spectral distributions P_{ε}(λ) are generated based on the spectral distribution data of various types of illumination, and by use of the spectral distributions P_{ε}(λ), the information processing device 100 is capable of determining the original color by eliminating the influence of the various types of illumination.

The above description has been given of the case where the color of the recognition target region is determined by using the LCh values and the determination table 111. It is also possible for the determination unit 170 to determine the color of the recognition target region by using the Lab values and a determination table. An example of the determination table will be shown below.

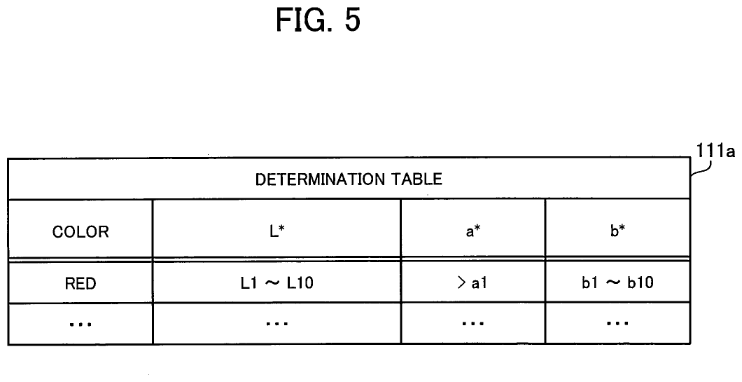

FIG. 5 is a diagram showing an example (No. 2) of the determination table. For example, the determination table 111a is stored in the storage unit 110. The determination table 111a is referred to also as the determination information. The determination table 111a indicates a correspondence relationship between the Lab values being values in the L*a*b* color space and colors.

The acquisition unit 120 acquires the determination table 111a from the storage unit 110 or an external device. Then, the determination unit 170 determines the color of the recognition target region by using the calculated Lab values and the determination table 111a. Specifically, the determination unit 170 determines the color of the recognition target region by using the L* value, the at value, the b′ value and the determination table 111a. Since the information processing device 100 determines the color by using the Lab values, the information processing device 100 does not execute the process of converting the Lab values to the LCh values. Accordingly, the information processing device 100 is capable of reducing the processing load on the information processing device 100.

Here, the determination table 111 and the determination table 111a are generated by a user, for example. The LCh values are easy to handle compared to the Lab values. Therefore, it is easier for the user to generate the determination table 111 rather than generating the determination table 111a. Thus, in the case where the information processing device 100 determines the color by using the LCh values, the table generation load on the user is reduced. The determination table 111 and the determination table 111a may be updated automatically. Further, the determination table 111 and the determination table 111a may be updated by the user.

Furthermore, the acquisition unit 120 may acquire a management table from the storage unit 110 or an external device. An example of the management table will be shown below.

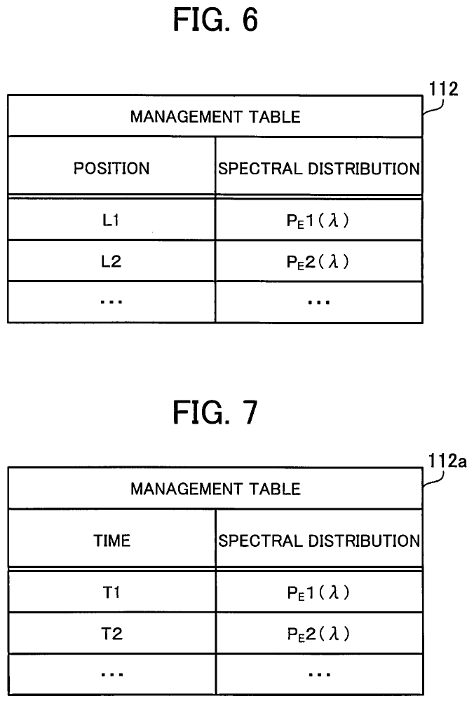

FIG. 6 is a diagram showing an example (No. 1) of the management table. For example, the management table 112 is stored in the storage unit 110. The management table 112 is referred to also as management information. The management table 112 indicates a correspondence relationship between the position and the spectral distribution. It can also be expressed that the management table 112 indicates a correspondence relationship between a plurality of positions and a plurality of spectral distributions.

The acquisition unit 120 acquires a photographing position of the object. The photographing position is the position at the time of photographing the object. For example, the acquisition unit 120 acquires the photographing position from the camera. The acquisition unit 120 acquires the spectral distribution corresponding to the photographing position based on the management table 112.

For example, sodium illumination has been installed at a spot A in a factory. The user photographs an object under the sodium illumination by using a camera. The acquisition unit 120 acquires the photographing position of the object from the camera. The photographing position is a position L1. The acquisition unit 120 acquires a spectral distribution P_{ε}1 (λ) corresponding to the photographing position based on the management table 112. The spectral distribution P_{ε}1 (λ) is a spectral distribution obtained by using the spectral distribution data, including data of the sodium illumination or data similar to the data of the sodium illumination, and the principal component analysis.

Further, for example, white LED illumination has been installed at a spot B in the factory. The user photographs an object under the white LED illumination by using a camera. The acquisition unit 120 acquires the photographing position of the object from the camera. The photographing position is a position L2. The acquisition unit 120 acquires a spectral distribution P_{ε}2 (λ) corresponding to the photographing position based on the management table 112. The spectral distribution P_{ε}2 (λ) is a spectral distribution obtained by using the spectral distribution data, including data of the white LED illumination or data similar to the data of the white LED illumination, and the principal component analysis.

As above, the information processing device 100 acquires a different spectral distribution depending on the photographing position. Then, the information processing device 100 is capable of determining the color of the recognition target region by using the spectral distribution corresponding to the photographing position.

The acquisition unit 120 may acquire a different management table from the storage unit 110 or an external device. An example of the management table will be shown below.

FIG. 7 is a diagram showing an example (No. 2) of the management table. For example, the management table 112a is stored in the storage unit 110. The management table 112a is referred to also as the management information. The management table 112a indicates a correspondence relationship between the time and the spectral distribution. It can also be expressed that the management table 112a indicates a correspondence relationship between a plurality of times and a plurality of spectral distributions.

The acquisition unit 120 acquires a photographing time of the object. The photographing time is the time of day at the time of photographing the object. For example, the acquisition unit 120 acquires the photographing time from the camera. The acquisition unit 120 acquires the spectral distribution corresponding to the photographing time based on the management table 112a.

Here, even in cases of photographing an object at the same position, the illumination can change depending on the time. For example, the sodium illumination is lit up for a time T1. The white LED illumination is lit up for a time T2. If the photographing time is in the time T1, the acquisition unit 120 acquires the spectral distribution P_{ε}1 (λ). If the photographing time is in the time T2, the acquisition unit 120 acquires the spectral distribution P_{ε}2 (λ).

As above, the information processing device 100 acquires a different spectral distribution depending on the photographing time. Then, the information processing device 100 is capable of determining the color of the recognition target region by using the spectral distribution corresponding to the photographing time.

### DESCRIPTION OF REFERENCE CHARACTERS

100: information processing device, 101: processor, 102: volatile storage device, 103: nonvolatile storage device, 110: storage unit, 111: determination table, 111a: determination table, 112: management table, 112a: management table, 120: acquisition unit, 130: generation unit, 140: calculation unit, 150: identification unit, 160: conversion unit, 170: determination unit

What is claimed is:

1. An information processing device comprising:
acquiring circuitry to acquire XYZ values being values corresponding to a recognition target region as an image region in an image obtained by photographing an object under first illumination and being values represented in an XYZ color model, a spectral distribution, spectral reflectance in a case of a perfect reflecting diffuser, and determination information indicating a correspondence relationship between Lab values being values in an L*a*b* color space and a color;
calculating circuitry to calculate Lab values as values corresponding to the recognition target region in the L*a*b* color space by using the XYZ values, the spectral distribution and the spectral reflectance in the case of the perfect reflecting diffuser;
determining circuitry to determine color of the recognition target region by using the calculated Lab values and the determination information; and
generating circuitry,
wherein
when the spectral distribution is generated, the acquiring circuitry acquires the XYZ values of a reference color and spectral reflectance of a spot in the reference color, the XYZ values of the reference color being calculated based on RGB values acquired from an image region of the reference color in the image obtained by photographing the object under the first illumination,
when the spectral distribution is generated, the generating circuitry generates a spectral distribution model by using principal component analysis and spectral distribution data including data of the first illumination or data similar to the data of the first illumination, and
the spectral distribution is acquired based on the XYZ values of the reference color, the spectral distribution model and the spectral reflectance of the spot in the reference color.

2. The information processing device according to claim 1, further comprising converting circuitry, wherein
the determination information indicates a correspondence relationship between LCh values being values in an L*C*h color space and a color,
the converting circuitry converts the calculated Lab values to LCh values as values corresponding to the recognition target region in the L*C*h color space, and
the determining circuitry determines the color of the recognition target region by using the LCh values obtained by the conversion and the determination information.

3. The information processing device according to claim 1, wherein the acquiring circuitry acquires a photographing position of the object and management information indicating a correspondence relationship between a position and the spectral distribution and acquires the spectral distribution corresponding to the photographing position based on the management information.

4. The information processing device according to claim 1, wherein the acquiring circuitry acquires a photographing time of the object and management information indicating a correspondence relationship between a time and the spectral distribution and acquires the spectral distribution corresponding to the photographing time based on the management information.

5. A determination method performed by an information processing device, the determination method comprising:
acquiring XYZ values being values corresponding to a recognition target region as an image region in an image obtained by photographing an object under first illumination and being values represented in an XYZ color model, a spectral distribution, spectral reflectance in a case of a perfect reflecting diffuser, and determination information indicating a correspondence relationship between Lab values being values in an L*a*b* color space and a color, and calculating Lab values as values corresponding to the recognition target region in the L*a*b* color space by using the XYZ values, the spectral distribution and the spectral reflectance in the case of the perfect reflecting diffuser; and
determining color of the recognition target region by using the calculated Lab values and the determination information,
wherein
when the spectral distribution is generated, acquiring the XYZ values of a reference color and spectral reflectance of a spot in the reference color, the XYZ values of the reference color being calculated based on RGB values acquired from an image region of the reference color in the image obtained by photographing the object under the first illumination, and generating a spectral distribution model by using principal component analysis and spectral distribution data including data of the first illumination or data similar to the data of the first illumination, and
generating the spectral distribution based on the XYZ values of the reference color, the spectral distribution model and the spectral reflectance of the spot in the reference color.

6. An information processing device comprising:
a processor to execute a program; and
a memory to store the program which, when executed by the processor, performs processes of,
acquiring XYZ values being values corresponding to a recognition target region as an image region in an image obtained by photographing an object under first illumination and being values represented in an XYZ color model, a spectral distribution, spectral reflectance in a case of a perfect reflecting diffuser, and determination information indicating a correspondence relationship between Lab values being values in an L*a*b* color space and a color, and calculating Lab values as values corresponding to the recognition target region in the L*a*b* color space by using the XYZ values, the spectral distribution and the spectral reflectance in the case of the perfect reflecting diffuser, and
determining color of the recognition target region by using the calculated Lab values and the determination information,
wherein
when the spectral distribution is generated, acquiring the XYZ values of a reference color and spectral reflectance of a spot in the reference color, the XYZ values of the reference color being calculated based on RGB values acquired from an image region of the reference color in the image obtained by photographing the object under the first illumination, and generating a spectral distribution model by using principal component analysis and spectral distribution data including data of the first illumination or data similar to the data of the first illumination, and
generating the spectral distribution based on the XYZ values of the reference color, the spectral distribution model and the spectral reflectance of the spot in the reference color.
